(19) United States
(12) Patent Application Publication
(10) Pub. No.: US 2012/0218312 A1
(43) Pub. Date: Aug. 30, 2012

(54) SYSTEM AND METHOD FOR ADJUSTING DISPLAY REGIONS FOR A DISPLAY ON AN ELECTRONIC DEVICE

(75) Inventors: Michael Andrew GOLDSMITH, Kitchener (CA); Kate Meredith DUDEK, Baden (CA); Bergen Albert FLETCHER, Kitchener (CA)

(73) Assignee: Research In Motion Limited

(21) Appl. No.: 13/034,007

(22) Filed: Feb. 24, 2011

(51) Int. Cl. G09G 5/10

(52) U.S. Cl. 345/690

(57) ABSTRACT

The disclosure describes a system and method for adjusting a display area for a display for an electronic device. The display system comprises: a display having a first region and a second region; a backlight for the display; and a display adjustment module located adjacent to the first region of the display, the display adjustment module having a first transmissivity mode where light from the backlight passes through the module to the first region and a second transmissivity mode where the light from the backlight is at least partially blocked from passing through the display adjustment module.

### FIELD OF TECHNOLOGY

The disclosure described herein relates to a system and method for adjusting display regions for a display on an electronic device. In particular, the disclosure described herein relates to adjusting boundaries of display to allow certain areas to be displayed in different contrast regions than other regions in the display.

### BACKGROUND

Current electronic devices perform a variety of functions to enable users to stay up-to-date with information and communications, such as e-mail, corporate data and organizer information while they are away from their desks. For many portable electronic devices, such as smart telephones, laptop computers, tablet devices or pagers a display of the device is fixed in size and it limited in how much information can be displayed at a time. In certain situations, multiple kinds of images (such as moving pictures, still pictures, other graphics, still text and animated text) may be displayed simultaneously.

### BRIEF DESCRIPTION OF THE DRAWINGS

The disclosure and its embodiments will now be described, by way of example only, with reference to the accompanying drawings, in which:

FIG. 1 is a schematic representation of an electronic device having a display and a display adjustment system for the display in accordance with an embodiment;

FIG. 2 is a block diagram of internal components of the device of FIG. 1 including the display and the display adjustment system of an embodiment;

FIG. 3A is a second schematic representation of the electronic device having the display and the display adjustment system of FIG. 1 in accordance with an embodiment;

FIG. 3B is a top view schematic representation of the display of FIG. 1 in accordance with an embodiment;

FIG. 3C is a top view schematic representation of a display adjustment module in accordance with an embodiment of FIG. 2;

FIG. 3D is a top view schematic representation of the display and the display adjustment module of FIG. 1 showing one output of the display and the display adjustment module;

FIG. 3E is a top view schematic representation of the display and the display adjustment module of FIG. 1 showing a second output of the display and the display adjustment module;

FIG. 4 is a cross-sectional side view block diagram of internal components of the display and the display adjustment module of FIG. 2;

FIG. 5 is a graph of a backlight level used for the display by an algorithm executed by a display adjustment module of FIG. 2; and

FIG. 6 is a flow chart of an algorithm executed by a display adjustment application system of FIG. 2.

### DESCRIPTION OF EMBODIMENTS

Described below are concepts that are useful with some kinds of displays. The concepts may be useful in displays of many different kinds, but may be especially desirable on portable electronic devices, especially portable electronic devices that are handheld (sized and shaped to be held or carried in a human hand) and portable electronic devices that have small displays. The concepts, described in the context of illustrative apparatus, methods and variant embodiments, generally adjust the display area of the display. One of the effects of the adjustment is that the light emitted by the display is controlled.

The description which follows and the embodiments described therein are provided by way of illustration of an example or examples of particular embodiments of the principles of the present disclosure. These examples are provided for the purposes of explanation and not limitation of those principles and of the disclosure. In the description which follows, like parts are marked throughout the specification and the drawings with the same respective reference numerals.

Generally an embodiment provides an adjustment system, method, module, algorithm and device for dynamically changing an effective viewing area for a display for an electronic device. Displays on an electronic device are fixed in size. However, an embodiment allows for the effective display area of the device to be changed (within its exterior limits). For example an embodiment allows the display area of a display to be configured for different purposes. One or more boundary areas can be defined for the display area and these boundary areas can be selectively changed such that the effective display area is changed to exclude those boundary areas.

In a first aspect, a display system for an electronic device is provided. The system comprises: a display having a first region and a second region; and a display adjustment module located adjacent to the first region of the display to control an amount of light either provided to or received from the first region, the display adjustment module having a first transmissivity mode where light passes through the display adjustment module and a second transmissivity mode where the light is at least partially blocked from passing through the display adjustment module.

The system may further comprise a backlight that emits the light emitted through the display. In the system, the display adjustment module may be located between the first region of the display and the backlight; the display adjustment module may control the amount of light provided to the first region; the display adjustment module may comprise a substrate containing particles having a first transmissivity region and a second transmissivity region; and control signals transmitted to the display adjustment module may align the particles in the substrate relative to the backlight and the display to align the first and second transmissivity regions in the substrate in first and second orientations to place the display adjustment module in the first and second transmissivity modes.

In the system, the particles may contain titanium.

In the system, the first orientation for the particles may allow more light to pass through the light adjustment module than the second orientations for the particles.

The system may further comprise an application operating a microprocessor in the electronic device to generate a first output on the display in the first region when the display adjustment module is in the first transmissivity mode and a second output on the display in the first region when the display adjustment module is in the second transmissivity mode.

In the system, for the application the first output may be an image being displayed on the second region of the display; and the second output may relate to text to accompany the image being displayed on the second region of the display.

In the system, for the application, the second region may define a boundary for a display region having approximately a 16:9 aspect ratio.

In the system, the second output may generate Secondary Audio Programming (SAP) text relating to the first output.

In the system, for the application, the first region may define a boundary for a display region having approximately a 4:3 aspect ratio.

In the system, an intensity of the backlight may be adjusted depending on whether the display adjustment module is operating in the first or the second transmissivity modes.

In the system, the display adjustment module may have a pixel density that exceeds a pixel density of the display.

In the system, the display may be a liquid crystal display.

In the system, the display adjustment module may comprise an electrophoretic display.

In the system, the display may be a self-emissive display; the display adjustment module may be located between the display and a lens of the device; and the display adjustment module may control the amount of light generated from the first region that passes through the display adjustment module.

In a second aspect, a display system for an electronic device is provided. The system comprises: a display having a first region and a second region; a backlight for the display; and a display adjustment module located adjacent to the first region of the display. The display adjustment module has an electrophoretic display providing a first transmissivity mode where light from the backlight passes through the module to the first region and a second transmissivity mode where the light from the backlight is at least partially blocked from passing through the display adjustment module.

In the system, the display may be a liquid crystal display; and the display adjustment module may be located between the first region of the display and the backlight.

In a third aspect, a method for controlling a display for an electronic device is provided. The method comprises: in a first mode, configuring the display having a first region and a second region to generate a first output on the display in the first region while controlling transmissivity of light through the first region to a first transmissivity level; and in a second mode, configuring the display to generate a second output on the display in the first region while controlling transmissivity of light through the first region to a second transmissivity level. In the method, the first transmissivity level transmits more light through the display than the second transmissivity level; and the transmissivity of light is controlled by a display adjustment module located adjacent to the first region of the display.

In the method, the display adjustment module may have an electrophoretic display providing the first and second transmissivity levels.

In the method, the second region may define a boundary for a display region having approximately a 16:9 aspect ratio.

In the method, the second output may generate SAP text relating to the first output.

In other aspects, various combinations and sub combinations of the above aspects are provided.

There are many scenarios in which it may be desirable to present one or more regions on a display as specially coloured, e.g., darker than other regions. One illustrative scenario is a display that presents images in different aspect ratios. For example, a display can have its internal display area present images in an approximately 4:3 aspect ratio and in approximately a 16:9 aspect ratio. The display may present images in different aspect ratios by selectively activating/deactivating boundary areas with the display area that would configure the height and length of the display area accordingly. As a further example, the display area can be modified to define a horizontal strip beneath (or above) an active display area in the overall display. The horizontal strip can be used to display supplemental text messages, such Secondary Audio Programming (SAP) text, closed captioning text, emergency broadcast messages, stock/news/weather tickers, etc. As a further example, the display can be partitioned into horizontal and/or vertical strips and/or one or more discrete sub-sections within the display area. Each section can be used to display different information, viewing angles, etc. for a given program, topic etc.

Such regions (strips, boundary areas, etc.) can be physically noted to define such boundaries for the display by changing the background colour of that portion of the display to a dark colour, such as black, blue, brown, etc. Alternatively, the background colour may be changed to match and/or complement colour schemes on the case of the device (e.g. a silver colour for a silver case, etc.). Alternatively and additionally, the colour of the regions can be made to match and/or complement the colour of a border on a lens covering the display. Such matching may provide an effect hiding a portion of the display (i.e. camouflaging it to appear to be part of the case) when the device is powered off.

As such, in one embodiment, boundary areas for a display are created by a display adjustment module that is located underneath the display in the device. In one embodiment, the display adjustment module selectively blocks light (completely or partly) or selectively allows light to pass through. As such, when an area is blocked, the corresponding region of the display is blocked from receiving backlight. This enhances the intensity of the black colour level for the blocked area (i.e., makes the black section appear more black). When the area is not blocked, the backlight passes through the display adjustment module and through the corresponding region of the display. In such a configuration, the backlight provided to the display is not affected by the display adjustment module.

In other configurations the display adjustment module provides partial blockage (anywhere between 0% and 100% transmissivity) of backlight to the display. In general, the display adjustment module may control transmissivity and may have one or more transmissivity modes, with each transmissivity mode having a level of transmissivity. The blockage may be provided as a greyscale or with other colours. The display adjustment module controls its transmissivity by controlling orientation of its internal structures. The internal structures may be any type of physical element (e.g. a series of particles, shutters, balls, liquid crystals etc.) that in a first orientation allow light to pass through and in a second orientation, block or reflect light. In orientations between those two orientations, degrees of transmissivity may be provided.

With some general features of an embodiment described, further detail is now provided on modules, components, application and devices that comprise an electronic device in an embodiment.

The term transmissivity refers to the ability of an object to transmit light (or other energy) through it. Transmissivity is a gradient from 0% (no transmissivity with complete blockage of light) to 100% (full transmissivity with complete passage of light).

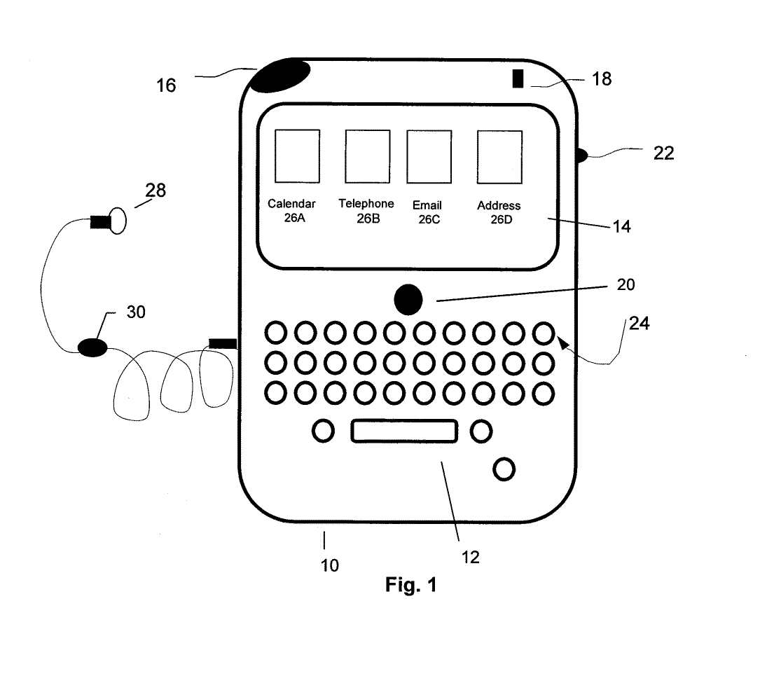

FIG. 1 shows an illustrative electronic device 10. The illustrative device 10 is sized and shaped to be held or carried in a human hand, and is capable of receiving electronic communications in accordance with an embodiment of the disclosure. In the present embodiment, electronic device 10 is based on a computing platform having functionality of an enhanced personal digital assistant with cellphone and e-mail features, or a smart phone. It is to be understood, however, that electronic device 10 can be based on construction design and functionality of other electronic devices, such as desktop computers, pagers, laptop computers, or tablet computers, and may but need not include telephony equipment. In a present embodiment, electronic device 10 includes a housing 12, a display 14 (which may be a liquid crystal display or LCD). Display 14 may present to a user images, which may include moving pictures, still pictures, graphics, text or other images. In general, one or more images make up the output of display 14. A lens (not shown) may cover display 14. Other elements may include speaker 16, a light emitting diode (LED) indicator 18, a directional user input device 20 (such as an optical track pad or a trackball), an ESC (“escape”) key 22, keypad 24, a telephone headset including an ear bud 28 and a microphone 30. User input device 20, ESC key 22 and keys of keypad 24 can be inwardly depressed or otherwise actuated to provide input signals to device 10.

Housing 12 can be made from any substantially rigid and durable material or materials, such as various combinations of plastics and metals, and may be formed to house and hold all components of device 10.

Device 10 is operable to conduct wireless telephone calls, using any known wireless phone system such as a Global System for Mobile Communications (GSM) system, Code Division Multiple Access (CDMA) system, CDMA 2000 system, Cellular Digital Packet Data (CDPD) system and Time Division Multiple Access (TDMA) system. Other wireless phone systems can include Wireless WAN (IMS), Wireless MAN (Wi-max or IEEE 802.16), Wireless LAN (IEEE 802.11), Wireless PAN (IEEE 802.15 and Bluetooth—trade-mark), etc. and any others that support voice. Additionally, a Bluetooth (trade-mark) network may be supported. Other embodiments include Voice over IP (VoIP) type streaming data communications that can simulate circuit-switched phone calls.

Various applications are provided on device 10, including email, telephone, calendar and address book applications. A graphical user interface (GUI) providing an interface to allow entries of commands to activate these applications is provided on display 14 through a series of icons 26. Shown are calendar icon 26A, telephone icon 26B, email icon 26C and address book icon 26D. Such applications can be selected and activated using the keypad 24 and/or the user input device 20. Further detail on selected applications is provided below.

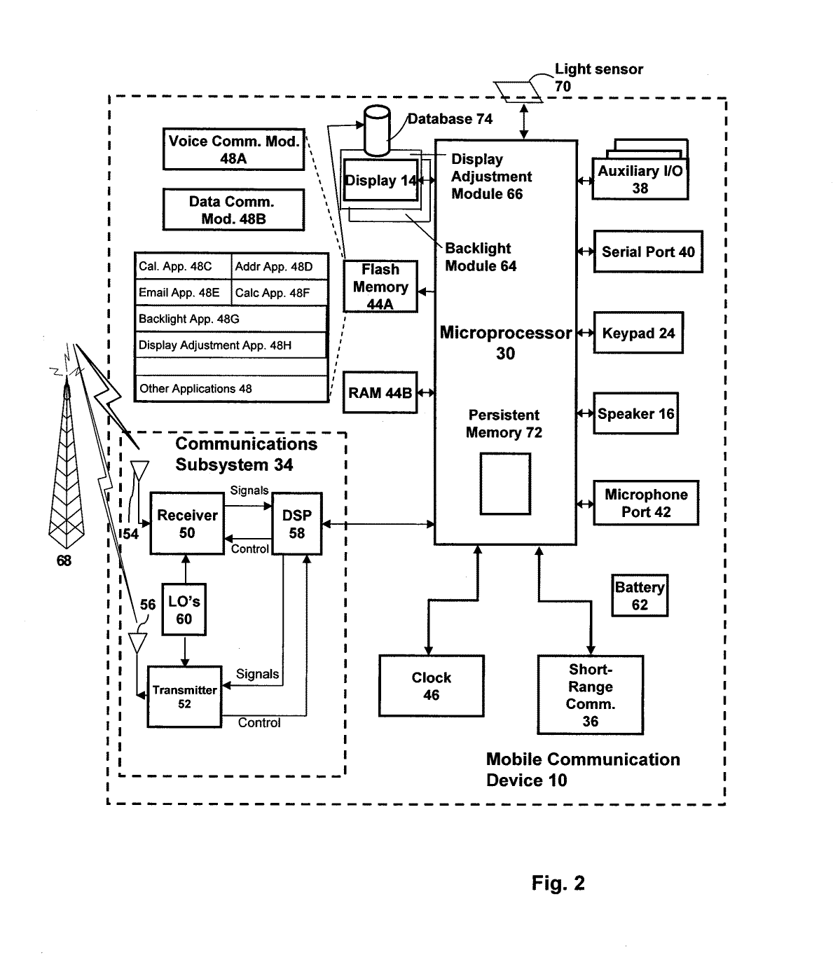

Referring to FIG. 2, functional elements of device 10 are provided. The functional elements are generally electronic or electro-mechanical devices. In particular, microprocessor 32 is provided to control and receive almost all data, transmissions, inputs and outputs related to device 10. Microprocessor 32 is shown schematically as coupled to keypad 24, display 14 and other internal devices. In this illustrative embodiment, microprocessor 32 controls the operation of the display 14, including the backlight and the display adjustment module 66. (In other embodiments, however, control of one or more outputs of the display 14 may be under the direction of one or more other processors.) Display 14 generates as output images, pictures, text, videos and other visual outputs in its display area. The display area may be segmented into regions, which each region being provided different output(s). In general, microprocessor 32 controls the overall operation of the device 10, and may do so in response to action by a user (such as actuation of keys on the keypad 24). Microprocessor 32 may control the overall operation of the device 10 and its components. Exemplary microprocessors for microprocessor 32 include microprocessors in the Data 950(trade-mark) series, the 6200 series and the PXA900 series, all available at one time from Intel Corporation (trade-mark).

In addition to microprocessor 32, other internal devices of the device 10 include: a communication subsystem 34; a short-range communication subsystem 36; keypad 24; and display 14; with other input/output devices including a set of auxiliary I/O devices through port 38, a serial port 40, a speaker 16 and a microphone port 42 for microphone 30; as well as memory devices including a flash memory 44A (which provides persistent storage of data) and random access memory (RAM) 44B; clock 46 and other device subsystems (not shown). The device 10 may be a two-way radio frequency (RF) communication device having voice and data communication capabilities. In addition, device 10 may have the capability to communicate with other computer systems via the Internet.

Operating system software executed by microprocessor 32 is stored in a computer readable medium, such as flash memory 44A, but may be stored in other types of memory devices (not shown), such as read only memory (ROM) or similar storage element. In addition, system software, specific device applications, or parts thereof, may be temporarily loaded into a volatile storage medium, such as RAM 44B. Communication signals received by the mobile device may also be stored to RAM 44B. Database 72 may be provided in flash memory 44A to store images, variables and run time data relating to applications 48.

Microprocessor 32, in addition to its operating system functions, enables execution of software applications on device 10. A set of software applications 48 that control basic device operations, such as a voice communication module 48A and a data communication module 48B, may be installed on the device 10 during manufacture or downloaded thereafter.

Communication functions, including data and voice communications, are performed through the communication subsystem 34 and the short-range communication subsystem 36. Collectively, subsystem 34 and subsystem 36 provide the signal-level interface for all communication technologies processed by device 10. Various other applications 48 provide the operational controls to further process and log the communications. Communication subsystem 34 includes receiver 50, transmitter 52 and one or more antennas, illustrated as receive antenna 54 and transmit antenna 56. In addition, communication subsystem 34 also includes processing module, such as digital signal processor (DSP) 58 and local oscillators (LOs) 60. The specific design and implementation of communication subsystem 34 is dependent upon the communication network in which device 10 is intended to operate. For example, communication subsystem 34 of the device 10 may be designed to operate with the Mobitex (trade-mark), DataTAC (trade-mark) or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access CDMA, Personal Communication Service (PCS), Global System for Mobile Communication (GSM), etc. Communication subsystem 34 provides device 10 with the capability of communicating with other devices using various communication technologies, including instant messaging (IM) systems, text messaging (TM) systems and short message service (SMS) systems.

In addition to processing communication signals, DSP 58 provides control of receiver 50 and transmitter 52. For example, gains applied to communication signals in receiver 50 and transmitter 52 may be adaptively controlled through automatic gain control algorithms implemented in DSP 58.

In a data communication mode a received signal, such as a text message or web page download, is processed by the communication subsystem 34 and is provided as an input to microprocessor 32. The received signal is then further processed by microprocessor 32 which can then generate an output to the display 14 or to an auxiliary I/O port 38. A user may also compose data items, such as e-mail messages, using keypad 24, user input device 20, or a thumbwheel (not shown), and/or some other auxiliary I/O device connected to port 38, such as a touchpad, a rocker key, a separate thumbwheel or some other input device. The composed data items may then be transmitted over communication network 68 via communication subsystem 34.

In a voice communication mode, overall operation of device 10 is substantially similar to the data communication mode, except that received signals are output to speaker 16, and signals for transmission are generated by microphone 30. Alternative voice or audio I/O subsystems, such as a voice message recording subsystem, may also be implemented on device 10.

Short-range communication subsystem 36 enables communication between device 10 and other proximate systems or devices, which need not necessarily be similar devices. For example, the short-range communication subsystem may include an infrared device and associated circuits and components, or a Bluetooth (trade-mark) communication module to provide for communication with similarly-enabled systems and devices.

Powering the entire electronics of the mobile handheld communication device is power source 62 (shown in FIG. 2 as a battery). Power source 62 may include one or more batteries. Power source 62 may be a single battery pack, such as a replaceable and/or rechargeable battery pack. A power switch (not shown) provides an “on/off” switch for device 10. Upon activation of the power switch an application 48 is initiated to turn on device 10. Upon deactivation of the power switch, an application 48 is initiated to turn off device 10. Power to device 10 may also be controlled by other devices and by internal software applications.

Display 14 has backlight system 64 (which may be referred to for convenience as “backlight”) to assist in the viewing display 14, especially under low-light conditions. A backlight system is typically provided for an LCD. A typical backlight system comprises a lighting source, such as a set of LEDs or a lamp located behind the LCD panel of the display, and a controller to control activation of the lighting source. The lamp may be fluorescent, incandescent, electroluminescent or any other suitable light source. As the lighting sources are illuminated, they emit light that is in turn emitted through the LCD panel, thereby providing backlighting to the display. The light emitted from the lighting source (or lighting sources) may be directed, distributed or scattered (e.g., by one or more reflective or refractive elements of light guides) so that the backlight appears substantially uniform across the display 14. In some displays, the backlight represents a principal source of the light emitted by the display. The intensity of the backlight level may be controlled by the controller by selectively activating a selected number of lighting sources (e.g. one, several or all LEDs) or by selectively controlling the activation duty cycle of the activated lighting sources (e.g. a duty cycle anywhere between 0% and 100% may be used). The activation cycle may be controlled through a series of time analog signals or a digital pulse train, such as a pulse-width modulation (PWM) signal. As will be described in more detail below, backlight system 64 can be made responsive to signals from a software module that determines a new brightness level for an image.

Display adjustment module 66 provides a substrate that selectively changes its transmissivity in certain areas (based on control signals provided to it) to block/reduce backlight from backlight system 64 from reaching selected output areas of display 14. In one embodiment, display adjustment module 66 is located between backlight system 64 and display 14.

In one embodiment, display adjustment module 66 comprises so-called electronic paper to provide the variable transmissivity through its substrate. Electronic paper comes in various forms, where a series of controllable “pixels” are provided. One form of electronic paper, known as Gyricon (trade-mark), comprises a sheet containing embedded small spheres (having a diameter of anywhere between about 60 and 110 micrometers). Each sphere has a charged dark (e.g. black, brown, blue etc.) side and an oppositely charged non-dark (e.g. light, white, clear, etc.) side. The dark and non-dark sides may oppose each other, but they may also be in on “orthogonal” sides to one another (where one side can be oriented upwards or downwards and the other side is oriented sideways). The sheet may be a transparent silicone sheet, with each sphere suspended in a bubble of oil so that they can rotate. It will be appreciated that the term spheres includes spherical objects and spheroids. Generally, any shape can be provided in the suspension for a particle (spheres, spheroids, cuboids, etc.) that has two different coloured regions, as long as the particle can be moved to provide different alignments for at least the two regions. Another form of electronic paper is an electrophoretic display (EPD). One form of an EPD has titanium dioxide particles suspended in oil with a dye and charging agents for the particles. This suspension is placed between two conductive plates. When a voltage is applied across the plates, the particles will migrate electrophoretically to the plate bearing the opposite charge from that on the particles. When the particles are located at the front (viewing) side of the EPD, it appears white, because light is scattered back to the viewer by high-index titanium particles. When the particles are located at the rear side of the EPD, it appears dark, because the incident light is absorbed by the dye. Most current EPDs provide two display: a black state (absorptive) and a white state (reflective), where neither one of these states transmits light from the backlight to the display that generates the image content. For other EPDs, a transmissive display state may also be provided. Other display technologies provide transmissive display states, such as bi-stable LCD technologies provided in cholesteric LCDs. An embodiment can utilize any of the display states provided by a display to modulate the amount of light passing therethrough (either from a backlight or from a self-emissive display).

In another embodiment, display adjustment module 66 may be implemented as a second LCD located underneath or above display 14. The transmissivity of the second LCD can be controlled to control the amount of backlight from the backlight system 64 reaching (and thereafter being emitted by) display 14.

In another embodiment, display adjustment module 66 located between display 14 and its lens, so that display 14 is between the display adjustment module and backlight system 64.

Display adjustment module 66 may comprise any substrate that can change its transmissivity in a selected region or area. For example, shutters may be moved in and out of the area to block light. Alternatively, the substrate may be filled with a liquid that selectively injects and removes a dye to block light from the area.

Light sensor 70 is provided on device 10. Sensor 70 is a light sensitive device which converts detected light levels into an electrical signal, such as a voltage or a current. It may be located anywhere on device 10, having considerations for aesthetics and operation characteristics of sensor 70. In one embodiment, an opening for light to be received by sensor 70 is located on the front cover of the housing of device 10 to reduce the possibility of blockage of the opening. In other embodiments, multiple sensors 70 may be provided and the software may provide different emphasis on signals provided from different sensors 70. The signal(s) provided by sensor(s) 70 can be used by a circuit in device 10 to determine when device 10 is in a well-lit, dimly lit or moderately-lit environment. This information can then be used to control backlight levels for display 14. In some embodiments, LED indicator 18 may be also used as a light sensor.

Brief descriptions are provided on some applications 48 stored and executed in device 10. Applications may also be referred to as modules and may include any of software, firmware and hardware to implement a series of commands and instructions to carry out their functions. Voice communication module 48A and data communication module 48B have been mentioned previously. Voice communication module 48A handles voice-based communication such as telephone communication, and data communication module 48B handles data-based communication such as e-mail. In some embodiments, one or more communication processing functions may be shared between modules 48A and 48B. Additional applications include calendar 48C which tracks appointments and other status matters relating to the user and device 10. Calendar 48C is activated by activation of calendar icon 26A on display 14. It provides a daily/weekly/month electronic schedule of appointments, meetings and events entered by the user. Calendar 48C tracks time and day data for device 10 using processor 18 and internal clock 46. The schedule contains data relating to the current accessibility of the user. For example it can indicate when the user is busy, not busy, available or not available. In use, calendar 48C generates input screens on display 14 prompting the user to input scheduled events through keypad 24. Alternatively, notification for scheduled events could be received via an encoded signal in a received communication, such as an e-mail, SMS message or voicemail message. Once the data relating to the event is entered, calendar 48C stores processes information relating to the event; generates data relating to the event; and stores the data in memory in device 10.

Address book 48D enables device 10 to store contact information for persons and organizations. Address book 48D is activated by activation of address book icon 26D on display 14. Names, addresses, telephone numbers, e-mail addresses, cellphone numbers and other contact information are stored. The data can be entered through keypad 24 and is stored in an accessible database in non-volatile memory, such as persistent storage 72 or flash memory 44A, which are associated with microprocessor 32, or any other electronic storage provided in device 10. Persistent memory 72 may a separate memory system to flash memory 44A and may be incorporated into a device, such as in microprocessor 32. Additionally or alternatively, memory 70 may removable from device 10 (e.g. such as a SD memory card), whereas flash memory 44A may be permanently connected to device 10.

Email application 48E provides modules to allow user of device 10 to generate email messages on device 10 and send them to their addressees. Application 48E also provides a GUI which provides a historical list of emails received, drafted, saved and sent. Text for emails can be entered through keypad 24. Email application 48E is activated by activation of email icon 26C on display 14.

Calculator application 48F provides modules to allow user of device 10 to create and process arithmetic calculations and display the results through a GUI.

Backlight adjustment application 48G provides the control signals to adjust the backlight 64. The backlight level can be set according to different factors including the detected ambient light from sensor 70, the brightness of the image being displayed, etc. When display adjustment module 66 is blocking selected areas of display 14, then application 48G may either increase the backlight level of backlight 64 (to enhance the contrast between the blocked areas of display 14 that are not being backlit and the unblocked areas of display 14 that are being backlit) or decrease its backlight level (to preserve power for the backlight). Backlight adjustment application 48G can generate an appropriate signal, such as a pulse width modulation (PWM) signal or values for a PWM signal, that can be used to drive a backlight 64 to an appropriate level as determined from the above noted situations. If backlight 64 utilizes a duty cycle signal to produce a backlight level, application 48G can be modified to provide a value for such a signal, based on inputs received.

Display adjustment application 48H provides instructions for controlling the transmissivity of display adjustment module 66. The transmissivity can be set according to predetermined conditions or events defined by application 48H or other applications 48. When display adjustment application 48H is controlling the transmissivity of display adjustment module 66, it may generate signals for other applications 48 indicating a transmissivity status of display adjustment module 66 for the information.

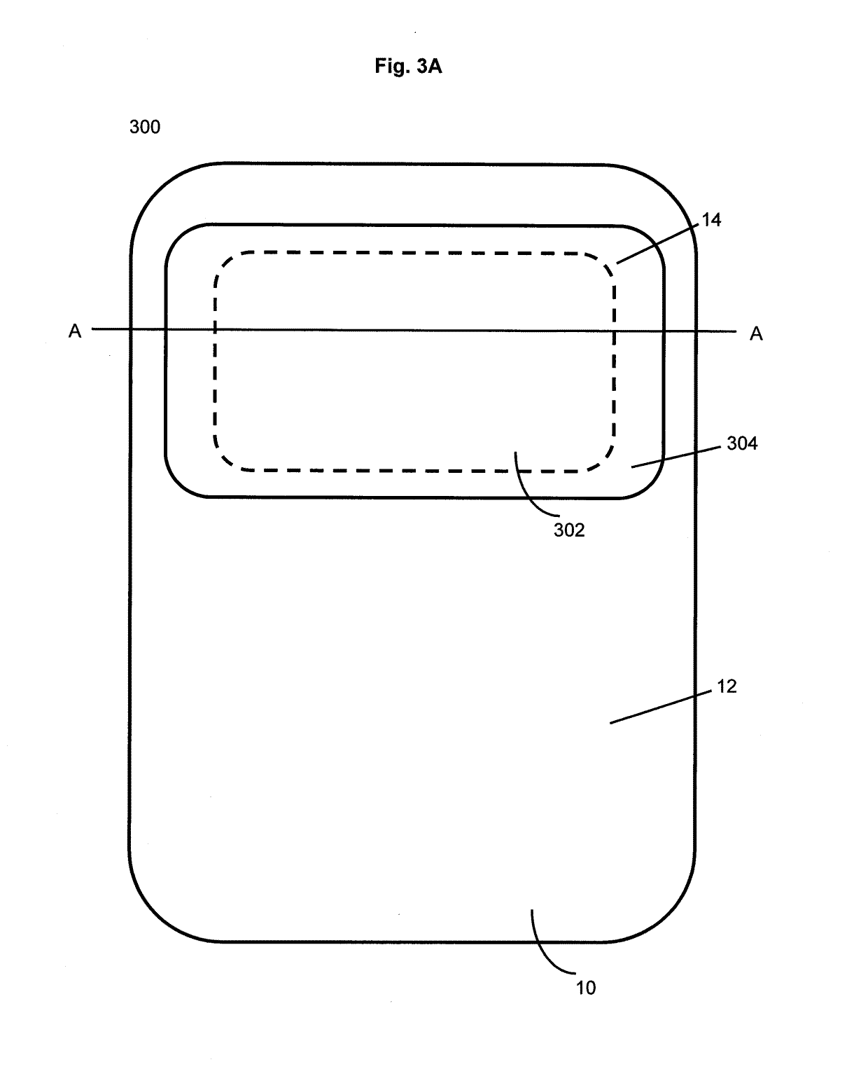

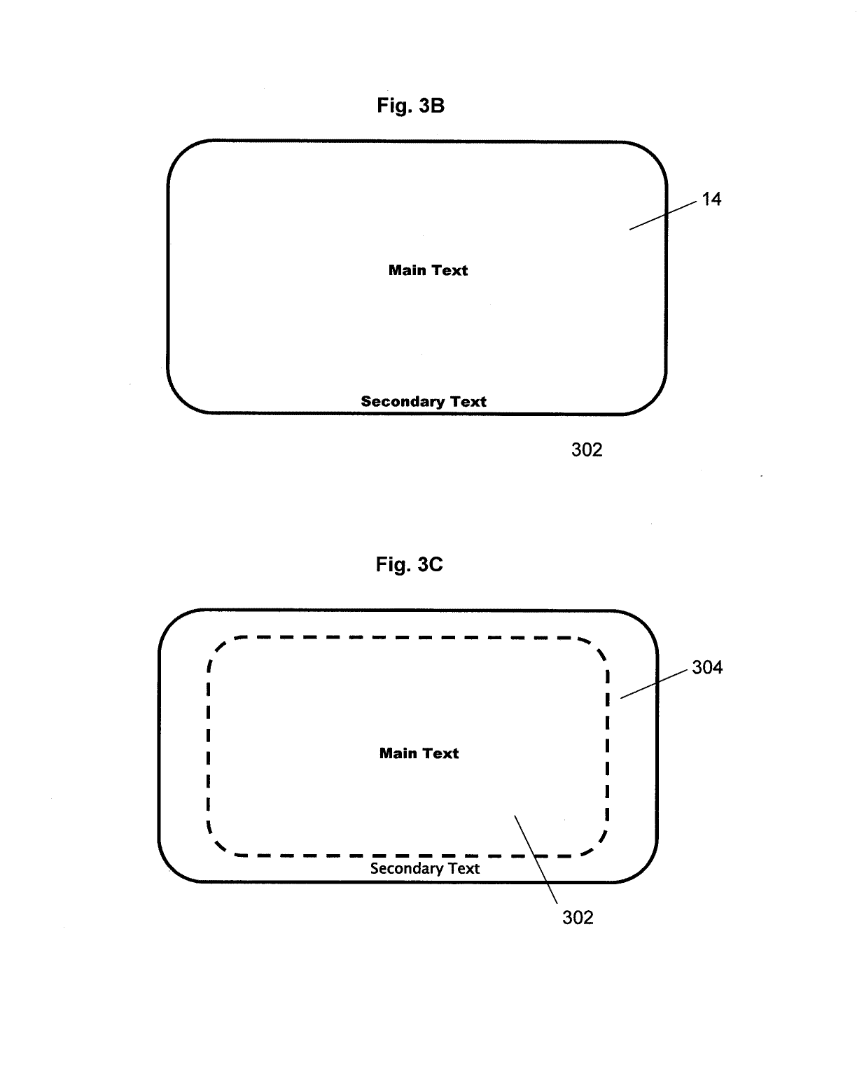

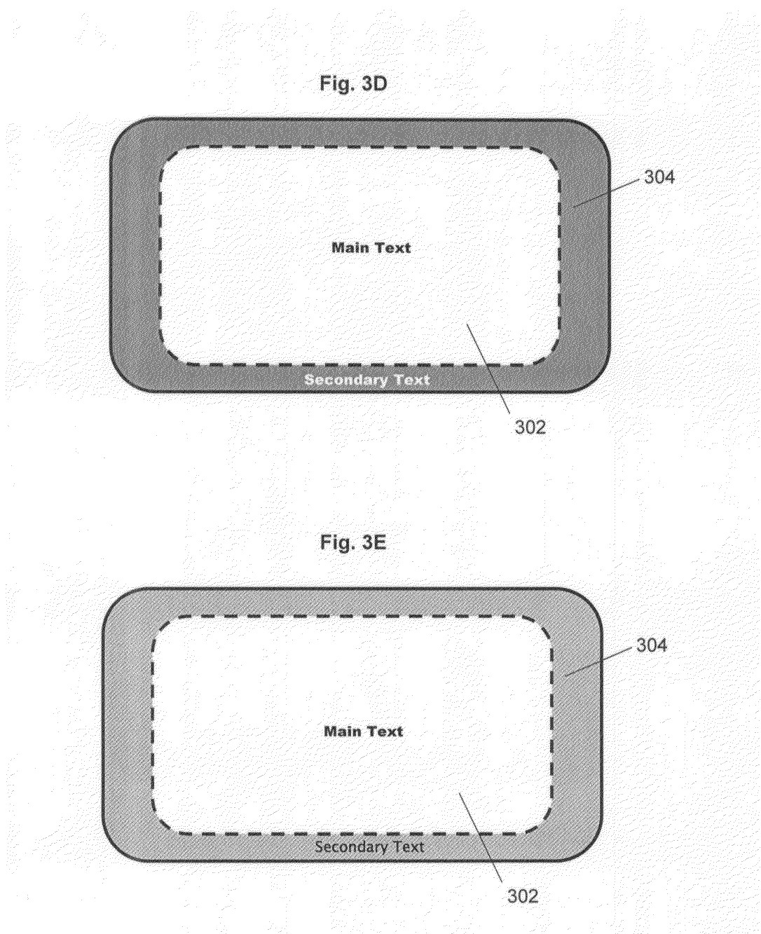

For example, in one embodiment an output generating application 48 (not shown) is provided to generate text or graphics or other images on display 14. When application 48H effectively changes the dimensions of display 14, a signal can be provided to the output generating application. As such, alternative text/graphics may be provided in the controlled region and/or additional text/graphics may be provided in the non-controlled region (see FIGS. 3D-3E below). Background colours for both regions can be changed. The output can be any image, including (but not limited to) nothing, enhanced text, SAP text, etc. for either the controlled or non-controlled regions.

Further detail is now provided on notable aspects of an embodiment. An embodiment provides a system and method for dynamically adjusting size of the displayed area of display 14. As display 14 is an LCD, backlight 64 provides luminance to make the displayed elements more visible. The level of light (i.e. brightness) that is perceived by a user viewing display 14 is a product of the degree of modulation by the LCD elements of display 14. When none of the LCD elements are activated (i.e. “on”), they do not impose a transmissive barrier between the backlight and the output of display 14. Display adjustment module 66 provides an interference means that selectively limits the amount of backlight provided to display 14 from backlight system 64. With these components, an embodiment can adjust the effective display area of display 14. As a corollary, an embodiment can intensify the blackness level of areas of display 14 that are deemed to be outside the effective display area. In other words, the dark areas may be more dark than they would otherwise be without the display adjustment module 66, since light that may otherwise be directed, distributed or scattered to the dark area would be blocked from being emitted.

Referring to FIGS. 3A-3C additional features of device 10 and display 14 are shown at 300.

In FIG. 3A, display 14 is shown with display area 302 surrounded by a band indicated by display area 304. The physical size of the display element (e.g. an LCD) for display 14 occupies area 304 plus area 302. Images such as moving pictures, still pictures, text, graphics, pixels, etc. can be selectively generated in area 304 and/or 302. Band area 304 may be selectively controlled by display adjustment module 66 as controlled by display adjustment application 48H. Band area 304 may be selectively darkened (by decreasing the transmissivity of the area) to lessen the amount of backlight from backlight system 64 that reaches the related area in display 14. Band area 304 can be considered to be a “blocking area” for display 14. For display 14, area 304 plus area 302 defines the display size, where an output is generated for display 14. The output is generally a visual output, the contents of which are controlled by the image data provided to display 14. The output may be multicoloured and/or monochrome. The output may be enhanced with backlight 64 and may be moderated by display adjustment module 66.

FIG. 3B shows a top view of display 14 alone. FIG. 3C shows a top view of display 14, with an illustration showing how much of the total surface area of display 14 may be affected by display adjustment module 66. As shown, display adjustment module 66 has a squared torus shape 304 with open center 306. Display adjustment module 66 is located underneath display 14 so that it aligns with display 14 and is interposed between backlight 64 and display 14. In other embodiments, display adjustment module 66 may affect more or less of the surface area of display 14, or may have any different shape or shapes. In still further embodiments, display adjustment module 66 may affect the entire surface area of display 14.

FIGS. 3D and 3E show two top views of display 14 with transmissivity of band area 304 controlled at different levels, i.e., with the display adjustment module operating in two illustrative transmissivity modes. A transmissivity mode is an operating state for the display adjustment module where a region of display 14 is specifically controlled to provide a local level of transmissivity, which may or may not be different than a level of transmissivity provided for another region of display 14. As shown, in area 304, the text “Main Text” is generated as an output of display 14. In area 304 supplementary text “Secondary Text” is generated. The amount of transmissivity in area 304 to backlight 64 is shown as two different levels of darkness. The boundary between areas 304 and 302 is shown with a dotted line; however, it will be appreciated that on display 14 itself, no line marking may be provided to indicate the boundary.

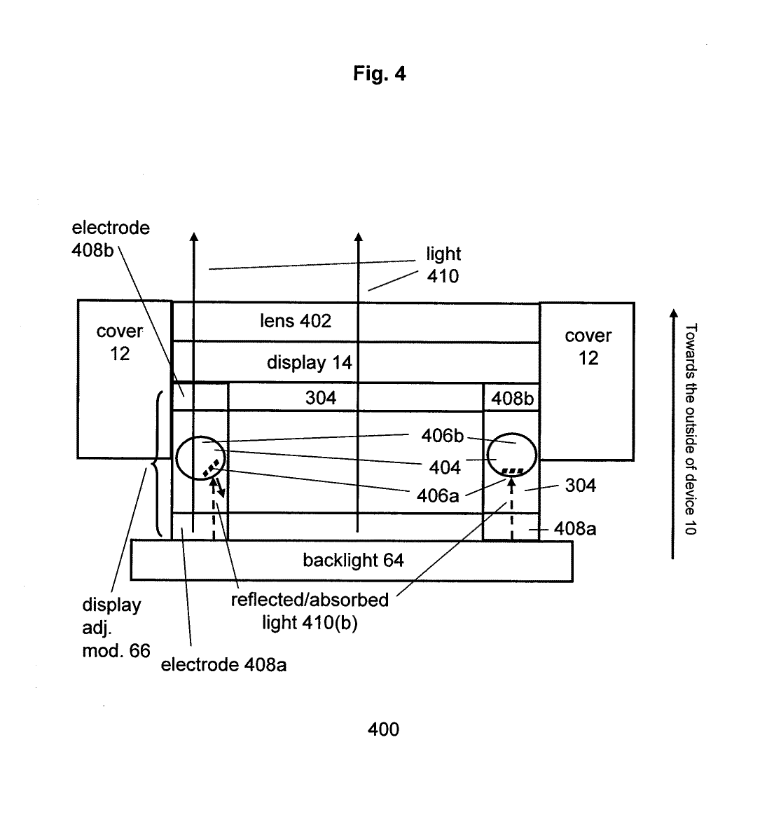

FIG. 4 shows a cross section 400 of device 10 with display 14, display adjustment module 66 (as indicated by display area 304 and electrodes 408a and 408b) and backlight system 64 shown in place. The cross-section is generated towards the interior of device 10 along line A-A of FIG. 3A. Lens 402 (which generally protects display 14 and may but need not provide any optical alteration of the light emitted from display 14) covers display 14. Lens 402 may incorporate a polarizing layer. Lens 402 may also incorporate translucent glass or plastic as a protective cover for components underneath. Display 14, for this embodiment, is an LCD. Top and bottom glass layers (not shown) may be provided for display 14. The top glass layer may be lens 402 or may be a separate component. Row and column electrodes for display 14 are not shown, but can be located in various locations around display 14 depending on transmission technologies for the installed display. A TFT LCD may have its row and column driving signals located in its bottom glass, where its top glass has a common electrode. Some display technologies do not have an electrode on the top glass, as their electric field is in plane as provided by electrodes located in the bottom glass. Electrodes can also be located on top and on bottom of display 14 (e.g. in the top and bottom glass layers) for other technologies. Display adjustment module 66 lies at the perimeter of display 14 (per FIGS. 3A-3C) and is located between backlight 64 and display 14. In other embodiments, display 14 and display adjustment module 66 can be switched in their order. Generally, display adjustment module 66 will be adjacent to display 14. Electrodes 408a and 408b provide charges for controlling orientation of particles 404. Electrodes 408a and 408b are shown on opposite sides of module 66; however, they can be located in various locations (e.g. both on top, both on bottom, on the sides, etc.) around module 66 depending on particle control technologies used to control orientation of particles 404 in module 66. As used herein, “adjacent to” means proximate to, which may mean (but does not necessarily mean) touching or abutting. There may be intermediary substrates between the two adjacent elements (e.g. foam spacers, etc.). Air gaps may or may not be provided between adjacent components. Components that are adjacent to one another may be, but need not be, affixed to one another or in a fixed position with respect to one another. For example, components that are on top of one another are adjacent to each other. As a general matter, display adjustment module 66 is adjacent to display 14 such that display adjustment module 66 affects the light emitted by display 14 or affects the image that a viewer may see. Backlight 64 may be located beneath both display adjustment module 66 and display 14 (that is, when viewing display 14 as uppermost). A bottom polarizing film may be provided (not shown) between backlight system 64 and components located above it.

Further detail is provided on display adjustment module 66 which is shown, figuratively, as having particles 404 therein. Display adjustment module 66 acts as a light “blocking layer” for backlight 64, by controlling the amount of transmissivity of particles 404 in display adjustment module 66. Control of transmissivity for this embodiment relates to providing signals to its electrodes (or other orienting devices) to adjust and orient one or more of the particles 404 in a specific region to a specific orientation to set a transmissivity level of light through that region. For one implementation, each particle 404 represents a pixel in area 304. Each particle 404 has a coloured region 406(a) and a non-coloured region 406(b). Particle 404 may be of any shape, but is shown as a sphere in FIG. 4. Coloured region 406(a) may be of any colour; however, it is often useful to be a darker colour to absorb light (e.g. dark blue, dark brown, dark grey, black, etc.). Non-coloured region 406(b) may be transparent, translucent or a different colour (such as a lighter colour) than coloured region 406(a). Non-coloured region 406(b) may be transparent, may allow a percentage of light to pass through (between about 100% and 10%), and/or may be white, yellow, light green, light blue, or other lighter/brighter colours than coloured region 406(a). Other regions on particle 404 may be the same or differently coloured from either coloured region 406(a) or non-coloured region 406(b) and/or be transparent, translucent or opaque. For the purposes of the disclosure, a “region” in a display defines a part of the display area of the display. There may be multiple regions in a display. The regions may or may not be contiguous to cover the entire display area (where an output image can be generated) for the display. Each region may have different display components and ancillary components (e.g. part of display adjustment module 66) associated with it.

Electrodes 408a and 408b are located on opposite sides of display adjustment module 66. The electrodes may be switched in polarity. They may be transparent, translucent and/or have opaque components. In FIG. 4 they are shown to be on the top and bottom of display adjustment module 66, but they may be placed in other locations (e.g. on the sides of display adjustment module 66), where suitable. Depending on the changes applied to electrodes 408a and 408b, a particle 404 would rotate/align to a certain orientation with coloured region 406(b) aligning in a particular orientation relative to backlight 64 (e.g. fully up, partially up, fully down).

Light 410 generated from backlight 64 travels upwards (towards display 14) through display adjustment module 66 and any non-reflected light continues to pass through to display 14, then through lens 402 to outside of device 10. Light 410 passes between particles 404 and/or through particles 404. Light 401b is also generated from backlight 64, but is reflected/absorbed by region 406(a), so that is does not directly transmit through display 14.

As shown in FIG. 4, particle 404 on the left is oriented such that some light 410 can transmit through its transparent/translucent body while some light 401a is reflected back towards backlight 66 or is absorbed by region 406a. Meanwhile, particle 404 on the right is oriented such that no light 410 can be transmitted through its body as all light 401a hits region 406a and is reflected back towards backlight 66 and/or is absorbed by region 406a. Another particle 404 (not shown) may be oriented to allow all light to pass through.

In other embodiments, layers shown in FIG. 4 may be re-arranged in different orders. For example, display 14 may be located underneath other components, such display area 302, display area 304 and display adjustment module 66. In such a configuration, an embodiment can be used on other display technologies, e.g. self-emissive display technologies (i.e. organic light emitting diode (OLED), plasma displays and cathode ray tube (CRT) displays). Such displays may or may not have a backlight associated with them. A self-emissive display internally generates its output and generally does not require a backlight. As such, for a self-emissive display, display adjustment module 66 is typically located between display 14 and a lens of the device to block output from the display itself. As such, display adjustment module 66 is located “on top” of self-emissive display 14. Herein display adjustment module 66 controls the amount of light generated from display 14 that passes through display adjustment module 66. In some embodiments, the lens may be omitted.

Typically, the pixel density for electronic paper is at least equal to and is generally greater that the pixel density of an LCD. The dots per inch (DPI) of electronic paper is generally between approximately 300 and 400 DPI. Higher DPI's for electronic paper, e.g. up to approximately 1200 DPI or more, may be provided. A LCD for display 14 currently has a pixel density of approximately 320 DPI. As such, there is not a 1:1 relationship between EPD pixels to LCD pixels. Accordingly, when the pixel density of display adjustment module 66 exceeds display 14, then additional contrast control is provided for display adjustment module 66. In one embodiment, gradients of transmissivity in the pixels in display adjustment module 66 that are aligned with a pixel in display 14. Notably the EPD “blocking layer” may provide a higher DPI than display 14. For implementations where the EPD has sufficient variable control of its transmission levels and where it can switch quickly (i.e. where it has a sufficiently fast response time), then it is possible to remove display 14 itself, except for its colour filters. In such a configuration, the EPD can be used to generate image/video content for the device instead of display 14.

It will be appreciated that display adjustment module 66 provides a separate control for the inherent brightness for a region (e.g. area 304, FIG. 3D) of display 14. For that region the image generated on display 14 (if any) can provide a separate brightness level. For example, to enhance the darkness of area 304, display adjustment module 66 can be set to fully block light from backlight 64 and display 14 can be set to generate “black” pixels in area 304. If any text is generated in area 64 by display 14, its colour can be set to a bright level (e.g. a bright white) to enhance its contrast over the black background.

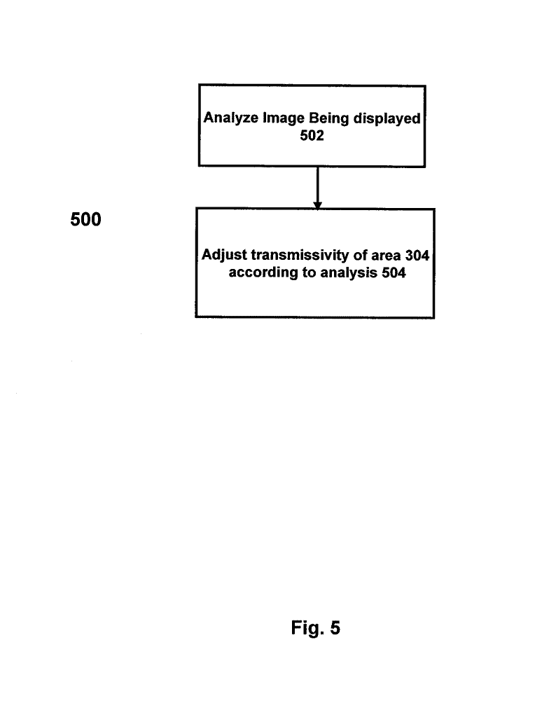

Referring to FIG. 5, in controlling operation of display adjustment module 66, an exemplary algorithm 500 executed by a processor (such as microprocessor 30) may analyze the content of a displayed image (as a frame) per process 502 and make adjustments to one or more areas 304 as to control their level of transmissivity and/or colour per process 504. For example, if the current image being displayed has a solid dark area which overlaps with an area 304, an algorithm may control display adjustment module 66 to darken the related section in area 304. For example, strips may provide deeper black bars above and below a content frame associated with a 16:9 aspect ratio, (or deeper black bars on the left and right sides of a content frame associated with a 4:3 aspect ratio). Similarly, an algorithm may change the transmissivity to enhance the contrast of the image based on the content of the image to be displayed. An algorithm may selectively enable or disable filters for an area 304 based on which application is launched, for example, a video player. By controlling the transmissivity of display adjustment module 66, the amount of backlight from backlight 64 that reaches display 14 can be modulated.

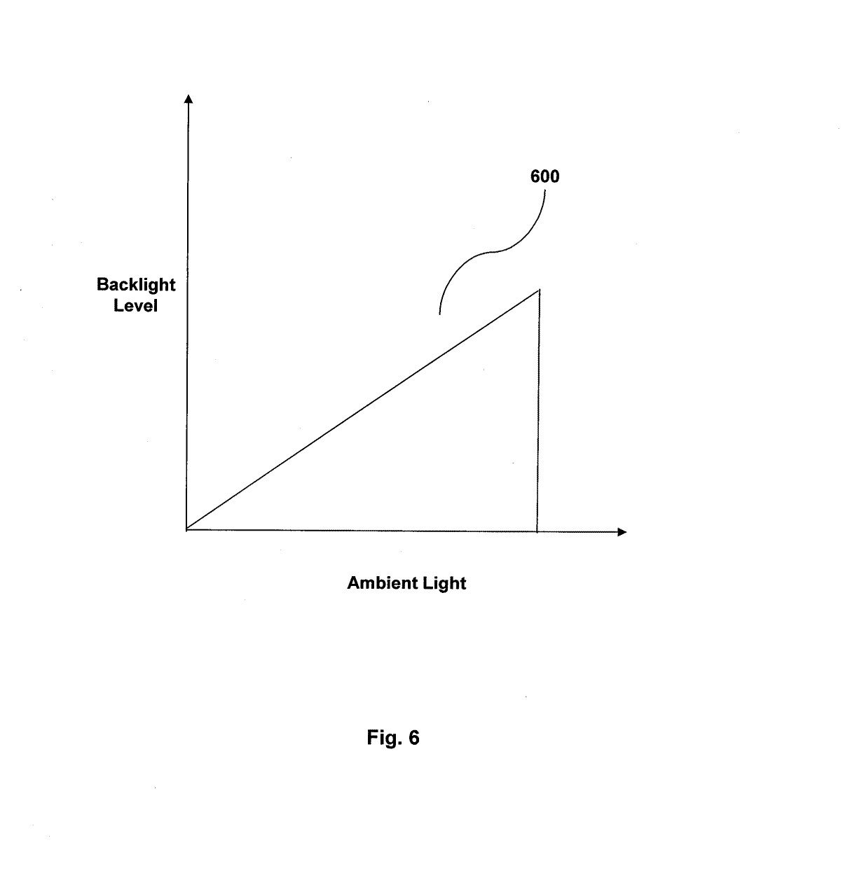

Referring to FIG. 6, as a further feature, an embodiment may generate an adjusted image as described above and adjust the backlight level and further adjust the backlight level to accommodate for the ambient lighting conditions surrounding device 10. Graph 600 shows a backlight level for display 14 on the y-axis compared against a level of ambient light of an environment surrounding device 14 on the x-axis, which can be detected by light sensor 70. As is shown, graph 600 has in a low backlight level when display 14 is in a very dark environment. As the amount of ambient light increases, the backlight level increases as well. Graph 600 provides a linear increase in backlight level intensity to as the amount of ambient light increases. The amount of backlighting calculated for an adjusted image may be further adjusted to accommodate for the ambient light reading. At a certain point, the ambient light conditions are very bright and as such, the backlight may not be very effective in those conditions. As shown in graph 600, at that point, backlighting may be turned off. A backlight level progression may be expressed as a formula, which may be used by software to determine an appropriate control signal for the controller of the backlight system for a given level of ambient light. In other embodiments, a backlight level progression may be stored as a table providing a set of backlight levels for a corresponding set of ambient light levels. In other embodiments, a series of different adjustment algorithms may be used. Processes to monitor ambient light signals as described may be incorporated into any application, such as backlight control application 48G.

In other embodiments, as a variation on FIG. 6, the backlight may be adjusted according to a non-linear curve (not shown) or progression. Therein, the progression may have plateaus, dips and peaks in its progression from a dark ambient light level to a bright ambient light level. The progression in one embodiment may be monotonically increasing, where the backlight level generally increases as ambient light increases. In other embodiments for other LCDs, other graphs of backlight level progressions may be used, including step-wise progressions and other non-linear progressions.

One of more of the embodiments described herein may realize one or more benefits, some of which have been mentioned already. The selective control of different regions or areas enables selective presentation of images that may be easier to see and may be more aesthetically pleasing. Different types of images may be displayed simultaneously (e.g., a moving picture and a subtitle text) with each type of image being displayed with clarity and with the images causing less interference with each other. The concepts described herein are flexible and may be applied to any device having a display screen, without express limitation of size. The concepts may be especially useful in handheld devices, however, because they may be implemented with little cost in terms of space, energy or weight.

It will be appreciated that display adjustment application 48H, display adjustment application 48G and other applications in the embodiments can be implemented using known programming techniques, languages and algorithms. The titles of the applications are provided as a convenience to provide labels and assign functions to certain application. As noted earlier, an application may also be referred to as a module. It is not required that each application perform only its functions as described above. As such, specific functionalities for each application may be moved between applications or separated into different applications. Applications may be contained within other applications. Different signalling techniques may be used to communicate information between applications using known programming techniques. Known data storage, access and update algorithms allow data to be shared between applications. It will further be appreciated that other applications and systems on device 10 may be executing concurrently with any application 48. As such, display adjustment application 48H and backlight adjustment application 48G may be structured to operate in as “background” applications on device 10, using programming techniques known in the art.

It will be appreciated that the embodiments relating to devices, servers and systems may be implemented in a combination of electronic hardware, firmware and software. The firmware and software may be implemented as a series of processes, applications and/or modules that provide the functionalities described herein. The algorithms and processes described herein may be executed in different order(s). Interrupt routines may be used. Data may be stored in volatile and non-volatile devices described herein and may be updated by the hardware, firmware and/or software.

As used herein, the wording “and/or” is intended to represent an inclusive-or. That is, “X and/or Y” is intended to mean X or Y or both.

In this disclosure, where a threshold or measured value is provided as an approximate value (for example, when the threshold is qualified with the word “about”), a range of values will be understood to be valid for that value. For example, for a threshold stated as an approximate value, a range of about 25% larger and 25% smaller than the stated value may be used. Thresholds, values, measurements and dimensions of features are illustrative of embodiments and are not limiting unless noted. Further, as an example, a “sufficient” match with a given threshold may be a value that is within the provided threshold, having regard to the approximate value applicable to the threshold and the understood range of values (over and under) that may be applied for that threshold.

The present disclosure is defined by the claims appended hereto, with the foregoing description being merely illustrative of an embodiment of the disclosure. Those of ordinary skill may envisage certain modifications to the foregoing embodiments which, although not explicitly discussed herein, do not depart from the scope of the disclosure, as defined by the appended claims.

1. A display system for an electronic device, comprising:
A display having a first region and a second region; and
a display adjustment module located adjacent to said first region of said display to control an amount of light either provided to or received from said first region, said display adjustment module having a first transmissivity mode where light passes through said display adjustment module and a second transmissivity mode where said light is at least partially blocked from passing through said display adjustment module.

2. The display system as claimed in claim 1, further comprising
a backlight that emits said light emitted through the display,
wherein
said display adjustment module is located between said first region of said display and said backlight;
said display adjustment module controls said amount of light provided to said first region;
said display adjustment module comprises a substrate containing particles having a first transmissivity region and a second transmissivity region; and
control signals transmitted to said display adjustment module align said particles in said substrate relative to said backlight and said display in first and second orientations to place said display adjustment module in said first and second transmissivity modes.

3. The display system as claimed in claim 2, wherein said particles contain titanium.

4. The display system as claimed in claim 2, wherein:
said first orientation for said particles allows more light to pass through said light adjustment module than said second orientations for said particles.

5. The display system as claimed in claim 1, further comprising:
an application operating a microprocessor in said electronic device to generate a first output on said display in said first region when said display adjustment module is in said first transmissivity mode and a second output on said display in said first region when said display adjustment module is in said second transmissivity mode.

6. The display system as claimed in claim 5, wherein for said application:
said first output is an image being displayed on said second region of said display; and
said second output relates to text to accompany said image being displayed on said second region of said display.

7. The display system as claimed in claim 1, wherein for said application:
said second region defines a boundary for a display region having approximately a 16:9 aspect ratio.

8. The display system as claimed in claim 6, wherein said second output generates Secondary Audio Programming (SAP) text relating to said first output.

9. The display system as claimed in claim 1, wherein for said application:
said first region defines a boundary for a display region having approximately a 4:3 aspect ratio.

10. The display system as claimed in claim 1, wherein:
an intensity of said backlight is adjusted depending on whether said display adjustment module is operating in said first or said second transmissivity modes.

11. The display system as claimed in claim 2, wherein said display adjustment module has a pixel density that exceeds a pixel density of said display.

12. The display system as claimed in claim 2, wherein:
said display is a liquid crystal display.

13. The display system as claimed in claim 12, wherein:
said display adjustment module comprises an electrophoretic display.

14. The display system as claimed in claim 1, wherein:
said display is a self-emissive display;
said display adjustment module is located between said display and a lens of said device; and
said display adjustment module controls said amount of light generated from said first region that passes through said display adjustment module.

15. A display system for an electronic device, comprising:
a display having a first region and a second region;
a backlight for said display; and
a display adjustment module located adjacent to said first region of said display, said display adjustment module having an electrophoretic display providing a first transmissivity mode where light from said backlight passes through said module to said first region and a second transmissivity mode where said light from said backlight is at least partially blocked from passing through said display adjustment module.

16. The display system as claimed in claim 15, wherein:
said display is a liquid crystal display; and
said display adjustment module is located between said first region of said display and said backlight.

17. A method for controlling a display for an electronic device, comprising:
in a first mode, configuring said display having a first region and a second region to generate a first output on said display in said first region while controlling transmissivity of light through said first region to a first transmissivity level; and
in a second mode, configuring said display to generate a second output on said display in said first region while controlling transmissivity of light through said first region to a second transmissivity level,
wherein
said first transmissivity level transmits more light through said display than said second transmissivity level; and
said transmissivity of light is controlled by a display adjustment module located adjacent to said first region of said display.

18. The method for controlling a display for an electronic device as claimed in claim 17, wherein:
said display adjustment module has an electrophoretic display providing said first and second transmissivity levels.

19. The method for controlling a display for an electronic device as claimed in claim 17, wherein:
said second region defines a boundary for a display region having approximately a 16:9 aspect ratio.

20. The method for controlling a display for an electronic device as claimed in claim 17, wherein:
said second output generates Secondary Audio Programming (SAP) text relating to said first output.
